(19) United States
(12) Patent Application Publication
(10) Pub. No.: US 2018/0207534 A1
(43) Pub. Date: Jul. 26, 2018

(54) METHOD AND DEVICE FOR PROCESSING USER DATA IN GAME FORUM

(71) Applicant: BEIJING QIHOO TECHNOLOGY COMPANY LIMITED, Beijing (CN)

(72) Inventor: Gen LI, Beijing (CN)

(21) Appl. No.: 15/744,705

(22) PCT Filed: Oct. 25, 2016
(86) PCT No.: PCT/CN2016/103214

§ 371 Date: Jan. 12, 2018

(30) Foreign Application Priority Data
Oct. 30, 2015 (CN) 201510729532.3

(51) Int. Cl. A63F 13/73; A63F 13/798; A63F 13/75

(52) U.S. Cl. CPC A63F 13/73; A63F 13/798; A63F 2300/5546; A63F 2300/5586; A63F 13/75

(57) ABSTRACT

The invention discloses a method and device for processing user data in a game forum. the method includes: the game forum includes a plurality of sections, user growth data of different sections are independent from each other; to each section of the game forum, recording growth data for the user in the section according to an attribute operation of each user in the section, determining an authority of the user in the section according to the growth data of the user in the section; and providing an operation authority of a corresponding level to the user in the section according to the authority of the user in the section.

### FIELD OF TECHNOLOGY

The present disclosure relates to the technical field of Internet game and, more particularly, to a method and device for processing user data in game forum.

### BACKGROUND

Forum is an Internet electronic information service system with strong interaction, abundant and timely content. It is preferred by lots of users. The users may acquire information, release information, discuss, chat in the forum. In the conventional technology, a plurality of sections corresponding to different subjects in the forum usually share one set of user growth system, including sharing the user growth data and user growth rule. In this data processing way of forum, no matter which section in the forum does a user perform an operation, all the sections will have the same user growth data, the same operation authority and even the same identification such as head portrait/title/level identification corresponding to the operation. For example, a forum includes section A, section B and section C, and a user is only interested in section B and therefore he or she only posts messages in section B. However, the user data in the above three sections are totally the same even the user only posts messages in section B. As a result, the user data in the conventional technology cannot show the user's traits such as interest and hobbies at all. The user data cannot reflect the relationship between each section and the subject, which causes the user fails to get sense of substitution, and further causes the separation of the sections in the forum meaningless.

### SUMMARY

In view of the above problems, there is provided a method and device for processing user data in a game forum, to overcome or at least partially solve the aforementioned problem.

According to an aspect of the present invention, there is provided a method for processing user data in a game forum, wherein the method comprises:

the game forum includes a plurality of sections, user growth data of different sections are independent from each other;

with respect to each section of the game forum, recording growth data for the user in the section according to an attribute operation of each user in the section, determining an authority of the user in the section according to the growth data of the user in the section; and providing an operation authority of a corresponding level to the user in the section according to the authority of the user in the section.

According to another aspect, there is provided a device for processing user data in a game forum, wherein the device comprises:

a setting unit, configured to divide the game forum into a plurality of sections, user growth data of different sections are independent from each other;

a processing unit, configured to, with respect to each section of the game forum, record growth data for the user in the section according to an attribute operation of each user in the section, determine an authority of the user in the section according to the growth data of the user in the section; and provide an operation authority of a corresponding level to the user in the section according to the authority of the user in the section.

According to another aspect, there is provided a computer program, comprising a computer-readable code, wherein when the computer-readable code runs on a computing device, the computing device is caused to execute the method for processing user data above.

According to another aspect, there is provided a computer-readable medium, storing the computer program above.

To sum up, to the situation that a game forum includes a plurality of sections and different sections correspond to different subjects, in the technical solution of the present invention, the user growth data in different sections are independent from each other, the user growth data in different sections reflect activity degrees of the user in different sections, respectively, and the corresponding rules of the user growth data and the authorities in different sections reflect rule differences in different sections, therefore it makes the user systems in different sections distinguish from each other, and makes the integration of the section with the section subject closer, which conforms to the section dividing intention of the game forum and improves user experience of the game forum.

Described above is merely an overview of a technical solution of the present invention. In order to more apparently understand the technical means of the present invention to implement in accordance with the contents of specification, and to more readily understand above and other objectives, features and advantages of the present invention, particular embodiments of the present invention are provided hereinafter.

### BRIEF DESCRIPTION OF THE DRAWINGS

Through reading the detailed description of the following preferred embodiments, various other advantages and benefits will become apparent to those of ordinary skills in the art. Accompanying drawings are merely included for the purpose of illustrating the preferred embodiments and should not be considered as limiting of the present invention. Further, throughout the drawings, like reference signs are used to denote like elements. In the drawings:

FIG. 1 is a flowchart displaying the method for processing user data in a game forum according to an embodiment of the present invention.

FIG. 2 is a schematic diagram displaying the device for processing user data in a game forum according to an embodiment of the present invention.

FIG. 3 is a block diagram of a computing device for executing the method for according to the present disclosure;

FIG. 4 illustrates a memory cell for holding or carrying program codes for realizing the method according to the disclosure.

### DESCRIPTION OF THE EMBODIMENTS

A further description of the present invention is made with reference to the accompanying drawings and specific embodiments hereinafter. The accompanying drawings display the exemplary embodiments of the present invention, the same or similar reference numbers represents the same or similar elements or the elements with similar function. The embodiments described with reference to the accompanying drawings are exemplary, which are used to explain the invention but not for limiting the present invention. In addition, if a descriptive illustration to a known technique is not necessary to show the feature of the invention, the descriptive illustration is omitted for concise purpose.

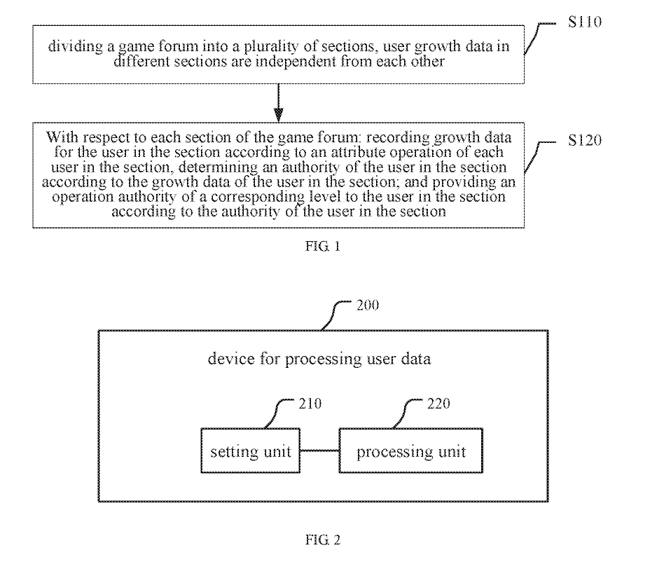

FIG. 1 is a flowchart displaying the method for processing user data in a game forum according to an embodiment of the present invention. As shown in FIG. 1, the method includes:

Step S110, dividing a game forum into a plurality of sections, user growth data in different sections are independent from each other;

Step S120, to each section of the game forum: recording growth data for the user in the section according to an attribute operation of each user in the section, determining an authority of the user in the section according to the growth data of the user in the section; and providing an operation authority of a corresponding level to the user in the section according to the authority of the user in the section.

As can be seen that, to the situation that the game forum includes a plurality of sections, and different sections correspond to different subjects, in the method shown in FIG. 1, the user growth data in different sections are made independent from each other, the user growth data in different sections reflect activity degrees of the user in different sections, respectively, and the corresponding rules of the user growth data and the authorities in different sections reflect rule differences in different sections, therefore it makes the user systems in different sections distinguish from each other, and makes the integration of the section with the section subject closer, which conforms to the section dividing intention of the game forum and improves user experience of the game forum.

In an embodiment of the present invention, the plurality of sections in the above-mentioned game forum correspond to different games, respectively; to integrate the user's experiences in the section and in the corresponding game closer, the method in FIG. 1 further includes: to each section in the game forum, acquiring attribute data of each user in the section in the corresponding game, taking the acquired attribute data as the attribute data of the user in the section.

Specifically, when the attribute data is visualization descriptive data such as head portrait/title/attack force, the acquiring attribute data of each user in the section in the corresponding game, taking the acquired attribute data as the attribute data of the user in the section includes: acquiring head portrait/title/attack force of each user in the section in the corresponding game, taking the acquired head portrait/title/attack force as the head portrait/title/attack force of the user in the section, thus the visualization descriptive data of the user in the game may be directly reflected in the section; or, acquiring head portrait/title/attack force of each user in the section in the corresponding game, taking the acquired head portrait/title/attack force as a specific head portrait/title/attack force of the user in the section; wherein the specific head portrait/title/attack force can exist at the same time with the head portrait/title/attack force of the section, and can represent a dual role of the user in the game and the forum.

Specifically, when the attribute data is growth data, the acquiring attribute data of each user in the section in the corresponding game, taking the acquired attribute data as the attribute data of the user in the section includes: acquiring growth data of each user in the section in the corresponding game, merging the acquired growth data with the growth data obtained according to the attribute operation of the user in the section, taking the merged growth data as the growth data of the user in the section, that is the growth track of the user in the section includes the growth track in the corresponding game, the positive performance of the user in the game may improve the growth data of the user in the section in order to get higher operation authority; or, acquiring growth data of each user in the section in the corresponding game, and taking the acquired growth data as specific growth data of the user in the section; wherein the specific growth data can exist at the same time with the growth data of the section, and can represent a dual growth track of the user in the game and the forum.

It can be seen that, under the situation that the sections are classified according to games, the above setting makes the section fuse together with the game, and to a same user, the descriptive feature in a game may also be reflected in the corresponding section, and the game identity may be combined with the section identity, which provides better sense of substitution, enjoyment, and better conforms to the situation requirement. For example, to a section of military game, the level and the title of the user in the section correlates with the military rank.

In an embodiment of the present invention, in the situation that each section of the game forum corresponds to a game, respectively, the method in FIG. 1 further includes: one-to-one pairing a section identification with a game identification, each pair of the section identification and the game identification correspond to a plurality of user identifications, and each user identification corresponds to a current growth data; correspondingly storing a section identification, a game identification, a user identification and the growth data obtained according to the attribute operation of the user in the section in a database;

then, acquiring the attribute data of each user in each section in the corresponding game includes: acquiring the attribute data of the user in the corresponding game from a corresponding game server according to the corresponding game identification and user identification.

In an embodiment of the present invention, the method in FIG. 1 further includes: setting different user growth rules for different sections of the game forum; the user growth rule includes: the corresponding relation between the attribute operation of the user in a section and the growth data of the user in the section; the corresponding relation between the growth data of the user in a section and the operation authority of the user in the section. For example, when a game corresponding to a section is a newly-launched game, it is capable to set a user growth rule under which the user growth data grow fast for the section, to popularize the newly-launched game.

In an embodiment of the present invention, the method in FIG. 1 further includes: to each user in the game forum, detecting whether the user have got an authentication from a specified platform via a server of the specified platform; if yes, determining an authentication authority of the user in each section according to an authentication level of the specified platform got by the user; in each section, providing corresponding operation authority for the user according to the authentication authority of the user in each section, and no longer performing the process of recording the growth data of the user in the section according to the attribute operation of the user in the section, the process of determining the authority of the user in the section according to the growth data of the user in the section, and the process of providing operation authority of corresponding level of the user in the section according to the authority of the user in the section.

In addition, to each user who has got the authentication of the specified platform, when detecting that the user loses the authentication of the specified platform, in each section, determining the authority of the user in the section according to the growth data of the user in each section, and providing operation authority of corresponding level to the user in the section according to the authority of the user in the section.

For example, generally each user grows in the section of the game forum according to a user growth system of each section, that is, to acquire growth data by providing attribute operation to each section, to acquire corresponding operation authority in each section by accumulating the growth data; when the user gets the authentication from the specified platform, such as obtaining an “honored player” authentication by top-up, the user may be off from the user growth system of each section, and may directly acquire corresponding operation authority in the identity of “honored player” in each section. It should be noted is, the authentication authority of each section is set according to the practical situation of the section, an authentication level has different authorities in different sections. After then, when the “honored player” authentication is invalid, the user may return to the user growth system of each section, and acquire the current growth data according to the history attribute operation in each section, and further obtain the current operation authority.

Based on the embodiments above, in the method shown in FIG. 1, providing operation authority of corresponding level to the user in the section according to the authority of the user in the section comprises: displaying an identification of corresponding level for the user in a page of the section according to the authority of the user in the section; and/or, providing operation options of corresponding level for the user in the page of the section according to the authority of the user in the section.

FIG. 2 is a schematic diagram showing the device for processing user data in a game forum according to an embodiment of the present invention. As shown in FIG. 2, the device for processing user data 200 in the game forum includes:

a setting unit 210, configured to divide the game forum into a plurality of sections, user growth data of different sections are independent from each other;

a processing unit 220, configured to, with respect to each section of the game forum, record growth data for the user in the section according to an attribute operation of each user in the section, determine an authority of the user in the section according to the growth data of the user in the section; and provide an operation authority of a corresponding level to the user in the section according to the authority of the user in the section.

As can be seen that, to the situation that the game forum includes a plurality of sections, and different sections correspond to different subjects, in the device shown in FIG. 2, by the cooperation of each unit of the device in FIG. 2, the user growth data in different sections are made independent from each other, the user growth data in different sections reflect activity degrees of the user in different sections, respectively, and the corresponding rules of the user growth data and the authorities in different sections reflect rule differences in different sections, therefore it makes the user systems in different sections distinguish from each other, and makes the integration of the section with the section subject closer, which conforms to the section dividing intention of the game forum and improves user experience of the game forum.

In an embodiment of the present invention, the plurality of sections correspond to a plurality of different games, respectively; the processing unit 220 is further configured to, with respect to each section in the game forum, acquire attribute data of each user in the section in the corresponding game, take the acquired attribute data as the attribute data of the user in the section.

In an embodiment of the present invention, processing unit 220 is configured to, acquire a head portrait/title/attack force of each user in the section in the corresponding game, take the acquired portrait/title/attack force as the head portrait/title/attack force of the user in the section; or, acquire the head portrait/title/attack force of each user in the corresponding game in the section, take the acquired head portrait/title/attack force as a specific head portrait/title/attack force of the user in the section.

In an embodiment of the present invention, the processing unit 220 is configured to, acquire growth data of each user in the section in the corresponding game, merge the acquired growth data with the growth data obtained according to the attribute operation of the user in the section, take the merged growth data as the growth data of the user in the section; or, acquire growth data of each user in the section in the corresponding game, and take the acquired growth data as the specific growth data of the user in the section.

In an embodiment of the present invention, the processing unit 220 is configured to: correspondingly store a section identification, a game identification, a user identification and the growth data obtained according to the attribute operation of the user in the section in a database; the processing unit is further configured to, acquire the attribute data of the user in the corresponding game from a corresponding game server according to the corresponding game identification and the user identification.

In an embodiment of the present invention, the processing unit 220 is further configured to: with respect to each user in the game forum, detect whether the user have got an authentication from a specified platform via a server of the specified platform; if yes, determine an authentication authority of the user in each section according to an authentication level of the specified platform got by the user; in each section, provide corresponding operation authority for the user according to the authentication authority of the user in each section.

In an embodiment of the present invention, the processing unit 220 is further configured to: with respect to each user who has got the authentication of the specified platform, when detecting that the user loses the authentication of the specified platform, in each section, determine the authority of the user in the section according to the growth data of the user in each section, and provide operation authority of corresponding level to the user in the section according to the authority of the user in the section.

In an embodiment of the present invention, the setting unit 210 is further configured to: set different user growth rules for different sections in the game forum, the user growth rule includes: a corresponding relation between the attribute operation of the user in a section and the growth data of the user in the section; wherein when a game corresponding to a section is a newly-launched game, it is capable to set a user growth rule under which the user growth data grow fast for the section.

In an embodiment of the present invention, the processing unit 220 is further configured to: display identification of corresponding level for the user in a page of the section according to the authority of the user in the section; and/or, provide operation options of a corresponding level for the user in the page of the section according to the authority of the user in the section.

It should be noted is, the embodiments of the device in FIG. 2 is the same with the embodiments of the method in FIG. 1, which are illustrated above, and is not illustrated for concise.

To sum up, to the situation that the game forum includes a plurality of sections, and different sections correspond to different subjects, in the technical solution provided by the invention, the user growth data in different sections are made independent from each other, user grow rules which are suitable for section requirement and subject requirement corresponding to sections are set for different sections, the user growth data in different sections reflect activity degrees of the user in different sections, respectively, and the user growth rules in different sections reflect rule differences in different sections, therefore it makes the user systems in different sections distinguish from each other, and makes the integration of the section with the section subject closer, and provides better sense of substitution, which conforms to the section dividing intention of the game forum and improves user experience of the game forum.

In addition, it is to be noted is:

Algorithm and display provided herein are not inherently related to a particular computer, virtual system or other equipment. Various general systems may also be used with the teaching based on the disclosure. According to the above description, the required structure for constructing such a system is obvious. In addition, the disclosure is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

Similarly, it should be understood that, in order to simplify the disclosure and to facilitate the understanding of one or more of various aspects thereof, in the above description of the exemplary embodiments of the disclosure, various features of the disclosure may sometimes be grouped together into a single embodiment, accompanying figure or description thereof. However, the method of this disclosure should not be constructed as follows: the disclosure for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the disclosure.

It should be understood by those skilled in the art that modules of the device in the embodiments can be adaptively modified and arranged in one or more devices different from the embodiment. Modules in the embodiment can be combined into one module, unit or component, and also can be divided into more sub-modules, sub-units or sub-components. Except that at least some of features and/or processes or modules are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the disclosure and forms the different embodiment. For example, in the claims, any one of the embodiments for which the protection is sought can be used in any combination manner.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

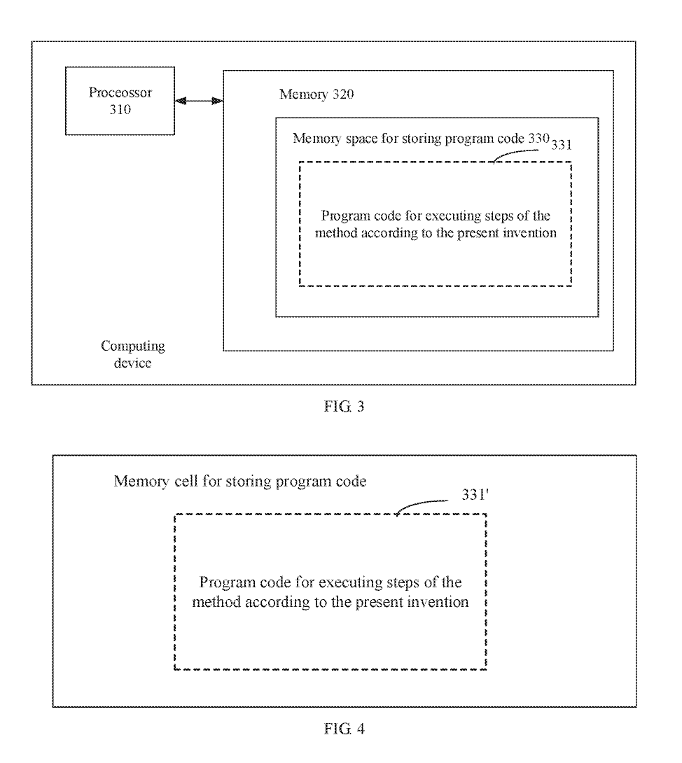

For example, FIG. 3 illustrates a block diagram of a computing device for executing the method according the disclosure. Traditionally, the computing device includes a processor 310 and a computer program product or a computer readable medium in form of a memory 320. The memory 320 could be electronic memories such as flash memory, EEPROM (Electrically Erasable Programmable Read-Only Memory), EPROM, hard disk or ROM. The memory 320 has a memory space 330 for executing program codes 331 of any steps in the above methods. For example, the memory space 330 for program codes may include respective program codes 331 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 4. The memory cells may be provided with memory sections, memory spaces, etc., similar to the memory 320 of the computing device as shown in FIG. 3. The program codes may be compressed for example in an appropriate form. Usually, the memory cell includes computer readable codes 331′ which can be read for example by processors 310. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

1. A method for processing user data in a game forum, wherein the method comprises:
the game forum includes a plurality of sections, user growth data of different sections are independent from each other;
with respect to each section of the game forum, recording growth data for the user in the section according to an attribute operation of each user in the section, determining an authority of the user in the section according to the growth data of the user in the section; and providing an operation authority of a corresponding level to the user in the section according to the authority of the user in the section.

2. The method according to claim 1, wherein the plurality of sections correspond to a plurality of different games, respectively,
the method further comprises: with respect to each section in the game forum, acquiring attribute data of each user in the section in the corresponding game, taking the acquired attribute data as the attribute data of the user in the section.

3. The method according to claim 2, wherein the acquiring attribute data of each user in the section in the corresponding game, taking the acquired attribute data as the attribute data of the user in the section comprises:
acquiring a head portrait/title/attack force of each user in the section in the corresponding game, taking the acquired head portrait/title/attack force as the head portrait/title/attack force of the user in the section;
or
acquiring a head portrait/title/attack force of each user in the section in the corresponding game, taking the acquired head portrait/title/attack force as a specific head portrait/title/attack force of the user in the section.

4. The method according to claim 2, wherein the acquiring attribute data of each user in the section in the corresponding game, taking the acquired attribute data as the attribute data of the user in the section comprises:
acquiring growth data of each user in the section in the corresponding game, merging the acquired growth data with the growth data obtained according to the attribute operation of the user in the section, taking the merged growth data as the growth data of the user in the section; or
acquiring growth data of each user in the section in the corresponding game, and taking the acquired growth data as specific growth data of the user in the section.

5. The method according to claim 2, wherein the method further comprises:
correspondingly storing a section identification, a game identification, a user identification and the growth data obtained according to the attribute operation of the user in the section in a database;
acquiring the attribute data of each user in each section in the corresponding game comprises:
acquiring the attribute data of the user in the corresponding game from a corresponding game server according to the corresponding game identification and the corresponding user identification.

6. The method according to claim 1, wherein the method further comprises:
with respect to each user in the game forum, detecting whether the user gets an authentication from a specified platform via a server of the specified platform; if yes, determining an authentication authority of the user in each section according to an authentication level of the specified platform; in each section, providing corresponding operation authority for the user according to the authentication authority of the user in each section.

7. The method according to claim 6, wherein the method further comprises:
with respect to each user who gets the authentication of the specified platform, when detecting that the user loses the authentication of the specified platform, in each section, determining the authority of the user in the section according to the growth data of the user in each section, and providing an operation authority of a corresponding level to the user in the section according to the authority of the user in the section.

8. The method according to claim 1, wherein the method further comprises:
setting different user growth rules for different sections in the game forum, wherein the user growth rule includes: a corresponding relation between the attribute operation of the user in a section and the growth data of the user in the section;
wherein when a game corresponding to a section is a newly-launched game, setting a user growth rule under which the user growth data grow fast for the section.

9. The method according to claim 1, wherein providing operation authority of corresponding level to the user in the section according to the authority of the user in the section comprises:
displaying an identification of corresponding level for the user in a page of the section according to the authority of the user in the section; and/or
providing operation options of corresponding level for the user in the page of the section according to the authority of the user in the section.

10. A device for processing user data in a game forum, wherein the device comprises:
a setting unit, configured to divide the game forum into a plurality of sections, wherein user growth data of different sections are independent from each other;
a processing unit, configured to, with respect to each section of the game forum, record growth data for the user in the section according to an attribute operation of each user in the section, determine an authority of the user in the section according to the growth data of the user in the section; and provide an operation authority of a corresponding level to the user in the section according to the authority of the user in the section.

11. The device according to claim 10, wherein the plurality of sections correspond to a plurality of different games, respectively;
the processing unit is further configured to, with respect to each section in the game forum, acquire attribute data of each user in the section in the corresponding game, take the acquired attribute data as the attribute data of the user in the section.

12. The device according to claim 11, wherein the processing unit is configured to,
acquire a head portrait/title/attack force of each user in the section in the corresponding game, take the acquired head portrait/title/attack force as the head portrait/title/attack force of the user in the section; or
acquire a head portrait/title/attack force of each user in the corresponding game in the section, take the acquired head portrait/title/attack force as a specific heads portrait/title/attack force of the user in the section.

13. The device according to claim 11, wherein the processing unit is configured to,
acquire growth data of each user in the section in the corresponding game, merge the acquired growth data with the growth data obtained according to the attribute operation of the user in the section, take the merged growth data as the growth data of the user in the section; or
acquire growth data of each user in the section in the corresponding game, and take the acquired growth data as the specific growth data of the user in the section.

14. The device according to claim 11, wherein the processing unit is configured to:
correspondingly store a section identification, a game identification, a user identification and the growth data obtained according to the attribute operation of the user in the section in a database;
the processing unit is configured to, acquire the attribute data of the user in the corresponding game from a corresponding game server according to the corresponding game identification and the corresponding user identification.

15. The device according to claim 10, wherein the processing unit is further configured to:
with respect to each user in the game forum, detect whether the user gets an authentication from a specified platform via a server of the specified platform; if yes, determine an authentication authority of the user in each section according to an authentication level of the specified platform got by the user; in each section, provide corresponding operation authority for the user according to the authentication authority of the user in each section.

16. The device according to claim 15, wherein the processing unit is further configured to:
with respect to each user who gets the authentication of the specified platform, when detecting that the user loses the authentication of the specified platform, in each section,
determine the authority of the user in the section according to the growth data of the user in each section, and provide an operation authority of a corresponding level to the user in the section according to the authority of the user in the section.

17. The device according to claim 10, wherein the setting unit is further configured to:
set different user growth rules for different sections in the game forum, wherein the user growth rule includes: a corresponding relation between the attribute operation of the user in a section and the growth data of the user in the section;
wherein when a game corresponding to a section is a newly-launched game, set a user growth rule under which the user growth data grow fast for the section.

18. The device according to claim 10, wherein the processing unit is further configured to:
display an identification of corresponding level for the user in a page of the section according to the authority of the user in the section; and/or
provide operation options of a corresponding level for the user in the page of the section according to the authority of the user in the section.

19.-20. (canceled)
